(19) United States
(12) Patent Application Publication
(10) Pub. No.: US 2008/0173182 A1
(43) Pub. Date: Jul. 24, 2008

(54) MACHINE FOR THE PREPARATION OF A HOT DRINK

(75) Inventors: Cornelius Boerner, Kuchen (DE); Armin Startz, Weidenstetten (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: WFM WUERTTEMBERGISCHE METALLWARENFABRIK AG, Gieslingen (DE)

(21) Appl. No.: 12/016,743

(22) Filed: Jan. 18, 2008

(30) Foreign Application Priority Data
Jan. 24, 2007 (EP) 07001477.4

(51) Int. Cl. A47J 31/44

(52) U.S. Cl. 99/281; 99/288; 99/285

(57) ABSTRACT

A machine for the preparation of a hot drink with a water tank, a closed brewing chamber and a region for the accommodation of a cup. In order to minimize the size of the machine, to simultaneously prevent the production of germination and to save manufacturing and operating costs, the capacity of the water tank is rated such that the amount of water is only sufficient for one cup of hot drink so that the water tank is empty at the end of brewing.

### CROSS-REFERENCE TO RELATED APPLICATION

The present application claims the benefit of priority of European Patent Application No. 07001477.4, filed Jan. 14, 2007. The entire text of the priority application is incorporated herein by reference in its entirety.

### FIELD OF DISCLOSURE

The disclosure relates to a machine for the preparation of a hot drink, as well as a single-cup system for the preparation of a cup of hot drink with a machine of this nature and with an appropriate standard cup.

### BACKGROUND

There are numerous coffee/pad machines on the market of different construction. The coffee/pad machines on the market have a water tank which can accommodate several cups of water. This water often stands many days in the tank and consequently can become contaminated or produce germination. The known appliances often have a choice of two different amounts of brewing water. The appropriate amount is, for example, requested via a button or a rotary potentiometer for setting the amount and a separate product button for starting the brew. With regard to its heating power, the heating system is designed such that the larger amount can be brewed in a good quality, although often only one cup is brewed. When heating up the system, the complete system must therefore be brought up to temperature, even if only one cup is to be brewed. With the machine switched on, appliances with boiler systems or unit heaters are held at temperature until the appliance is switched off by the customer or an automatic switch-off occurs after a certain time. In this way long heating up times for a following product, which would be required for the large heating system are compensated. In this respect very much energy is consumed.

Furthermore, the known coffee/pad machines are put into operation by pressing a button. An additional button is required for the product selection. Here, either the product is discharged as long as the button is pressed or the product is discharged until the button is pressed again after pressing the button for a first time. It is also possible that the product is discharged in a certain amount/time after the button is first pressed. To switch off the appliance, the on/off button must be pressed again or the appliance switches itself off after a certain standby period.

Due to their large tank size the known machines for preparing hot drinks have relatively large dimensions and thus, because different amounts of brewing water are made available, they also require a heating system with a high heating power, which is expensive and furthermore involves a high energy consumption. Furthermore, the systems on the market often spend a long time in the standby mode and thus also consume a large amount of energy. Operation of the known machines is also often complicated.

### SUMMARY OF DISCLOSURE

Starting from this, the object of the present disclosure is to provide a machine for the preparation of a hot drink, which has a minimum size, which does not tend to produce germination and which can furthermore be operated easily and in an economical manner.

According to the disclosure the size or the capacity of the water tank are designed such that the amount of water is only sufficient for one cup of hot drink so that the water tank is empty at the end of the brewing. Thus, contamination due to keeping water in the tank for a long period can be prevented. Since the tank size is small, the overall size of the machine can be significantly reduced.

The machine according to the disclosure has a heating system which heats the water from the tank, wherein the water in the heating system, e.g. a boiler system, can be heated. Also during brewing, water can be fed into the boiler system from the tank. The control unit is designed such that an amount of energy is fed to the heating system which is required for the amount of water for only one cup of hot drink. This means that the machine can in an advantageous way be controlled such that the complete amount of water from the tank is brewed so that no residual water is left in the water tank. In an advantageous way, the machine according to the disclosure therefore has only a brewing amount, for which the heating system has to be rated. Thus, in contrast to conventional appliances, the brewing water for one cup can be provided in a more energy efficient manner. Due to the smaller heating system, the machine comes up to the operating temperature quickly, also for following cups. Since the heating system has a very low rating here, space and manufacturing costs as well as operating costs can be saved.

In an advantageous way the machine only has one button, wherein the machine switches on after the button has been pressed once and the specified amount of energy is passed to the heating system and the brewing process is carried out with the machine switching off automatically thereafter. Thus, energy for the heated standby mode is not wasted as with other appliances.

In a further advantageous embodiment an illuminated indicator, which indicates the operating states, is assigned to the button of the machine. Thus for example, the operator can quickly see whether the button has already been pressed and that the heating system is heating up the brewing water. If the illuminated indicator is not lit, the user can quickly see that the machine is switched off. In an advantageous way the illuminated indicator is arranged as an illuminated ring around the button.

In a further advantageous development the region for the accommodation of the cup is formed as a chamber which is open at the face side of the appliance. Thus, a cup exactly fitting the machine can be inserted into the chamber. The formation of the region for the accommodation of the cup as a chamber open at the face side again saves space.

It is advantageous if the machine has a brewing chamber which can be completely removed. Thus, no high technical complexity is required for the sealing mechanism of the machine. The brewing chamber can thus be separated completely from the appliance with one grasp of the hand.

In an advantageous way the completely removable brewing chamber is located in the chamber in which the Cup is also accommodated. Thus, the brewing chamber to be removed is easily accessible.

In an advantageous way a longitudinal section through the chamber has an essentially complementary shape to the cup, so that the cup can be arranged in the chamber in a space-saving manner. When the brewing chamber is designed to be placed in the receptacle chamber, a cavity remains, the longitudinal section of which similarly has an essentially complementary shape to the cup.

A single-cup system for the preparation of a cup of hot drink has a machine and at least one appropriate standard cup, which for example can also have a handle. Here, the internal contour of the chamber is adapted to the external contour of the cup. In particular, if the cup has a handle, the inner surface of the chamber is formed in such a manner that it has a region for the accommodation of the handle. Thus, the size of the region for the accommodation of the cup can be minimized, by means of which the size of the machine can in turn be minimized.

### BRIEF DESCRIPTION OF THE DRAWINGS

The present disclosure is explained in more detail below with reference to the drawings.

Here FIG. 1 shows a schematic, perspective view of the machine according to the disclosure.

FIG. 2 shows a schematic, perspective illustration of the machine according to the disclosure with the brewing chamber removed.

FIG. 3 illustrates schematically the operation of the machine according to the disclosure.

FIG. 4 illustrates schematically individual components of the machine.

FIG. 5 illustrates schematically a plan view onto the chamber for the accommodation of the cup.

FIG. 6 illustrates schematically a longitudinal section along the line I-I in FIG. 5.

FIG. 7 illustrates an exploded view of the main parts of the machine according to the disclosure.

FIG. 8 illustrates schematically a side view of the machine shown in FIG. 1.

### DETAILED DESCRIPTION

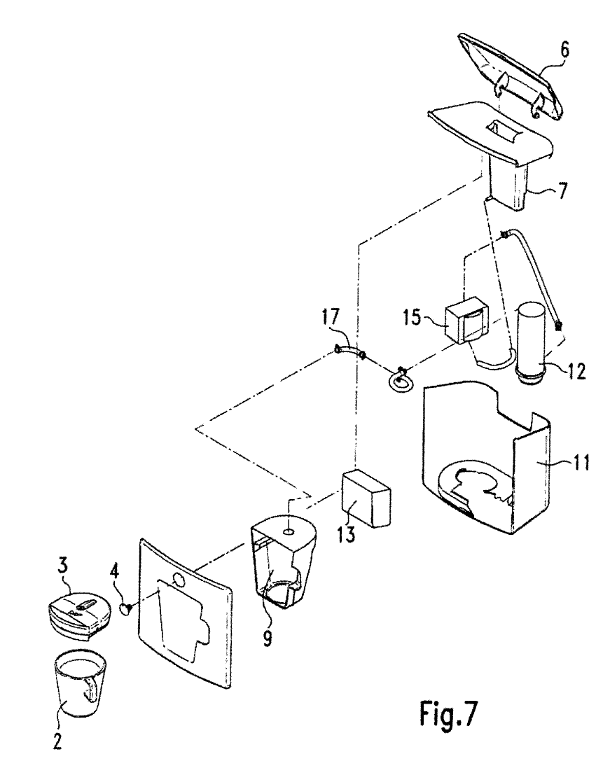

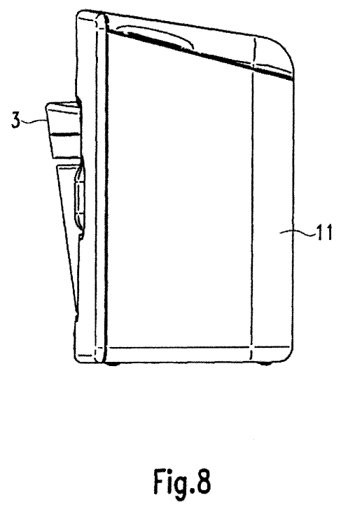

FIG. 1 shows in a perspective illustration a possible embodiment of a machine 1 for the preparation of a hot drink. FIG. 7 shows an exploded view of the most important components. A machine 1 of this nature can for example prepare coffee or tea, etc. The machine 1 has a housing 11, which on its upper side has a cover 6, with which the housing 1 can be opened and closed. In the housing 11 there is a water tank 7 with a filling-level mark 8, up to which water can be filled for the hot drink. The machine 1 is a single-cup machine. The size or the volume capacity of the water tank 7 is designed such that it can only accept the amount of water required for producing one cup 2 of a hot drink. The predetermined volume is here, for example, in a range of approximately 100 to 200 ml depending on the size of the cup. Due to the small water tank volume, the tank is empty at the end of the brewing. Thus, no contamination can occur due to keeping water in the tank for a long period.

Furthermore, the machine 1 has a heating system 12 illustrated in FIG. 7 (refer also to FIG. 4) which heats the water from the water tank 7. Here, boiler systems or unit heaters can be employed. The heating system 12 is rated such that it is sufficient for heating an amount of water for only one cup of hot drink. The machine 1 therefore has only a brewing amount for which the size and power of the heating system 12 is rated. Therefore with the single-cup system according to the disclosure only the amount of energy is passed which is required for providing one cup of brewing water. Thus, in contrast to other appliances, the brewing water for one cup can be provided in a more energy efficient manner.

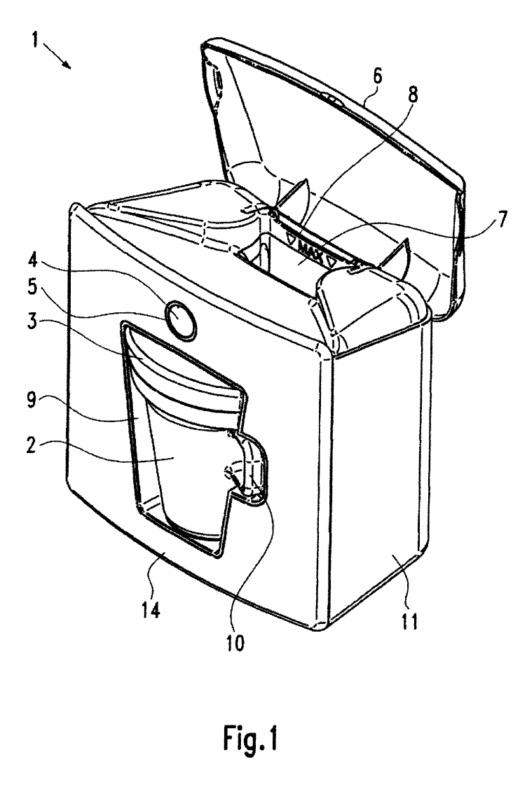

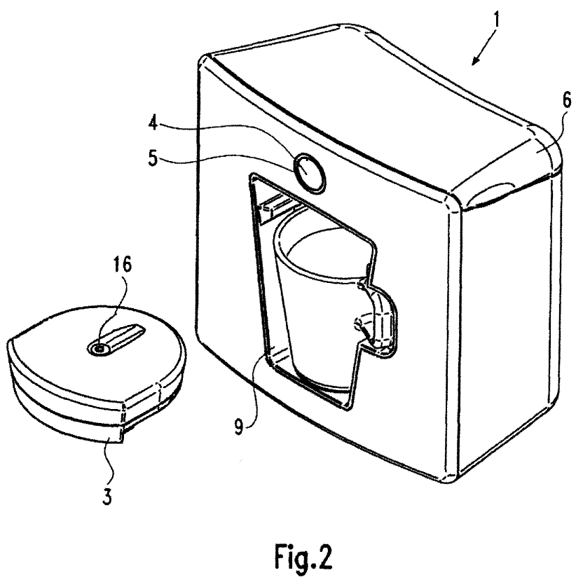

Furthermore, as can be seen from FIGS. 1 and 2, the machine has a region 9 for the accommodation of a cup 2 into which the hot drink is discharged. The region 9 is here formed as a chamber 9 which is open at the front 14 of the housing 11. Here, a completely removable brewing chamber 3 is provided in the chamber 9. Completely removable means that both the upper part and also the lower part of the brewing chamber can be removed from the machine as a complete unit. Different brewing media, e.g. coffee powder or coffee pads or tea powder or capsules, can be charged into the brewing chamber. The closed brewing chamber 3 can then be inserted into a drawer region of the machine, here into the chamber 9. In the upper region of the brewing chamber 3 there is a sealing element 16, which connects the brewing chamber 3 in a sealed manner to a feeder pipe 17 for hot brewing water which is pumped out of the water tank 7 at high pressure with the aid of the pump 15. At the lower end of the brewing chamber 3 there is an outlet (not illustrated), through which the hot drink can flow into the cup 2.

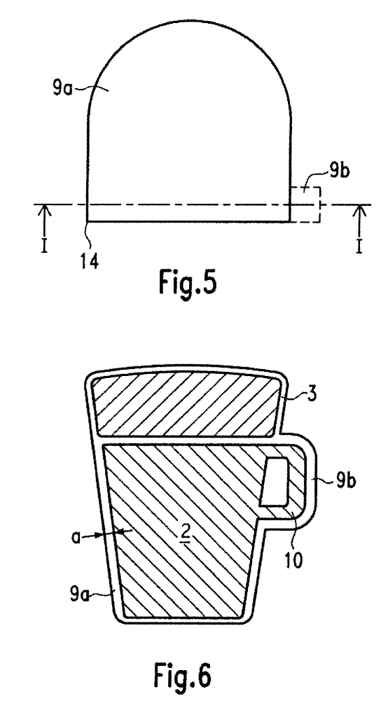

The size of the chamber 9 is selected such that a cup 2 can be located there. The shape of the chamber 9 is shown in greater detail in FIGS. 5 and 6. FIG. 5 illustrates a plan view onto the chamber 9 which comprises a main chamber part 9a and a side region 9b. FIG. 6 is a longitudinal section through the chamber 9. The inserted brewing chamber 3 is located in the upper region of the chamber 9. With an inserted brewing chamber 3 a cavity is produced, the longitudinal section of which along the line I-I in FIG. 5, which runs parallel to the face side 14 of the housing 11, has a shape which matches, i.e. is essentially complementary to, the shape of the cup 2 located in it. This means that the inner side of the chamber 9 is matched to the shape of the cup 2. A space should be provided between the cup 2 and the chamber 9 so that the cup can be easily inserted and removed. In order that also cups with handles can be used, the chamber 9 has at least on one side a region 9b which extends from a side wall of the main region 9a sidewards to accommodate for example a handle 10 of the cup 2. This embodiment facilitates a very space-saving arrangement of the region for the accommodation of the cup 2 so that overall space can be saved.

As can be seen from FIG. 8, the inserted brewing chamber 3 protrudes beyond the chamber 9 and here beyond the face side 14. This enables the brewing chamber to be easily grasped.

Furthermore, the machine 1 only has one button 4 for the complete operation. The button 4, which is formed here as a pushbutton, has an illuminated indicator 5, here in the form of an illuminated ring 5.

FIG. 4 shows schematically the operation of the machine 1.

The button or the switch 4 is connected to the control unit 13 which in turn is connected to the heating system 12, pump 15 and to the illuminated indicator 5. The illuminated indicator 5 here indicates the main operating states of the machine.

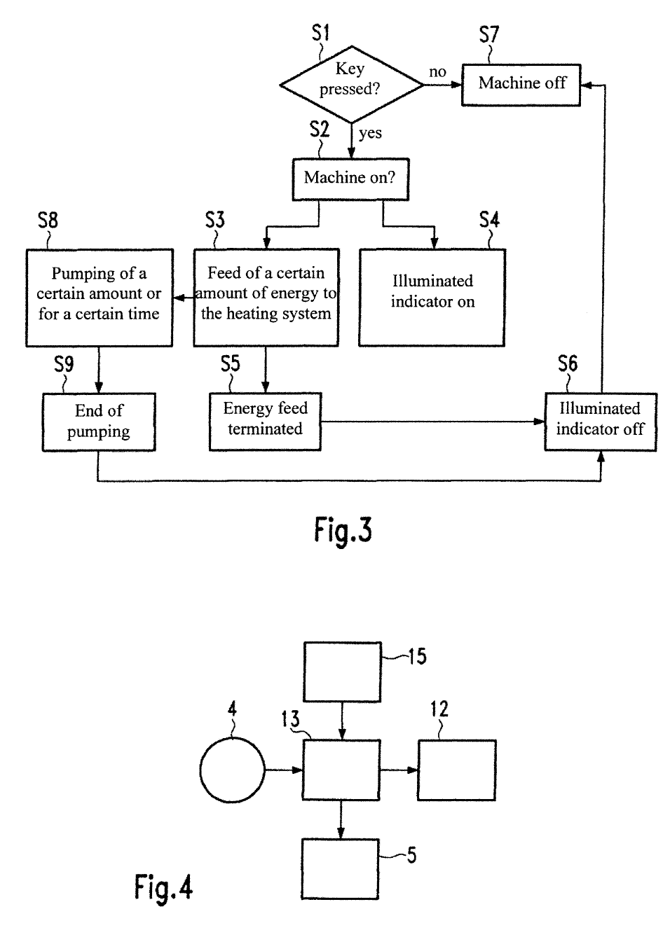

The functioning principle of the machine 1 according to the disclosure is clarified in conjunction with FIG. 3. According to the disclosure, the machine 1 has only one button. When the button 4 is pressed (S1), the machine switches on (S2). The machine 1 is then controlled by the control unit 13 such that precisely the amount of water is brewed which is located in the tank. That is, the specific amount of energy is supplied to the heating system 12 which is required to produce brewing water for one cup 2 (S3) and all the water is pumped out of the tank. The water here is heated in the boiler system 12. Also during brewing, water can be fed into the boiler system from the tank 7. The specific amount of energy can be specified beforehand in dependence of the cup volume, i.e. it can be constant. However, it is also possible to determine the end of the heating process via appropriate measurements (e.g. temperature or pressure, etc.). At the same time the control unit 13 also switches the illuminated indicator on (S4) which lights up and thus indicates that the machine is in operation.

Once an adequate amount of energy has been passed, the energy feed is terminated (S5). The heated water can then or during heating be pressed into the brewing chamber 3 under high pressure through an appropriate pipe through the seal device 16. To achieve this, a certain amount is pumped or pumping occurs for a certain time (S8), and thereafter the pumping process is terminated (S9). Steps S3 and S8 can also run in parallel, at least partially.

A specific amount of product can then be discharged into the cup at the lower end of the brewing chamber 3.

After termination of the energy feed, the control unit 13 can immediately switch off the illuminated indicator or after a certain time period (S6). The machine then switches off automatically (S7). The machine remains switched off as long as the button 4 is not pressed.

The heating system is heated up with just the press of a button and switches off when the energy fed is sufficient for the defined brewing amount. In this way energy for the heated standby mode is not wasted as with known appliances. Due to the small boiler system, which is rated for only one cup of brewing water, the machine quickly heats up to the operating temperature also for following cups.

Advantageously, a single-cup system for preparing one cup of a hot drink here has the machine 1 according to the disclosure as well as at least one suitable standard cup 2, the volume of which is known, wherein the size and shape of the chamber, as previously described, match the cup 2 and also the heating power of the heating system 12 and the charging volume of the tank 7 are adapted to the cup volume.

1. Machine (1) for the preparation of a hot drink, comprising a water tank (7), a closed brewing chamber (3), a chamber (9) for the accommodation of a cup (2), and the capacity of the water tank (7) is rated such that the amount of water is only sufficient for one cup (2) of hot drink, so that the water tank (7) is empty at the end of the brewing.

2. Machine (1) according to claim 1, wherein the machine (1) also has a heating system (12), which heats the water, wherein a control unit (13) is designed such that an amount of energy, which is required for the amount of water for only one cup of hot drink, is passed to the heating system (12).

3. Machine (1) according to claim 2, and a button (4), wherein the machine is switched on when the button is pressed, the defined amount of energy is fed to the heating system (12), the brewing process is carried out and thereafter the machine (1) is automatically switched off.

4. Machine (1) according to claim 3, and an illuminated indicator (5) is assigned to the button (4) for indicating the operating states.

5. Machine (1) according to claim 4, wherein the illuminated indicator (5) is arranged as an illuminated ring around the button (4).

6. Machine (1) according to claim 1, wherein the chamber (9) for the accommodation of the cup is formed as a chamber which is open at the face side of the machine (1).

7. Machine (1) according to claim 1, wherein the machine (1) has a completely removable brewing chamber.

8. Machine (1) according to claim 7, wherein the brewing chamber (3) is arranged in the chamber (9) for removal.

9. Machine (1) according to claim 6, and wherein a longitudinal section through the chamber (9) for removal has a shape essentially complementary to the cup.

10. Machine (1) according to claim 8, wherein the brewing chamber (3) inserted in the chamber (9) for removal forms a cavity, the longitudinal section of which cavity has a shape essentially complementary to the cup (2).

11. Single-cup system for the preparation of a cup of hot drink, comprising a machine according to claims 1 and at least one standard cup (2).

12. Single-cup system according to claim 11, and wherein the cup has a handle (19) and the chamber formed on at least one side of the chamber (9) for removal has a region (9b) extending laterally from the chamber wall for the accommodation of a handle.
